(19) United States
(12) Patent Application Publication
(10) Pub. No.: US 2017/0299449 A1
(43) Pub. Date: Oct. 19, 2017

(54) SENSING SYSTEM

(71) Applicant: DENSO CORPORATION, Kariya-city, Aichi-pref. (JP)

(72) Inventor: Takuya NAKAMURA, Kariya-city (JP)

(73) Assignee: DENSO CORPORATION, Kariya-city, Aichi-pref (JP)

(21) Appl. No.: 15/515,893

(22) PCT Filed: Oct. 29, 2015
(86) PCT No.: PCT/JP2015/005443

§ 371 Date: Mar. 30, 2017

(30) Foreign Application Priority Data
Nov. 4, 2014 (JP) 2014-224213

(51) Int. Cl. G01L 3/10; G01L 1/16; G01K 11/26

(52) U.S. Cl. CPC G01L 3/10; G01K 11/265; G01L 1/16

(57) ABSTRACT

A sensing system includes: a surface acoustic wave sensor with a first surface acoustic wave device-and a second surface acoustic wave device; a sensing apparatus detecting an electrical characteristic of the first and second surface acoustic wave devices connected to the surface acoustic wave sensor; and a control apparatus calculating a physical quantity acting on one of a target to which the surface acoustic wave sensor is attached and the surface acoustic wave sensor. The sensitivity ratio of a first physical quantity and the sensitivity of a second physical quantity are different, and a third physical quantity is removable by averaging. The control apparatus removes the first physical quantity based on the results of a comparison operation on sensor signals from the first and second surface acoustic wave elements, uses the averaging process to remove the third physical quantity, and thereby calculates the second physical quantity.

### CROSS REFERENCE TO RELATED APPLICATIONS

This application is a U.S. national stage application of International Patent Application No. PCT/JP2015/005443 filed on Oct. 29, 2015 and is based on Japanese Patent Application No. 2014-224213 filed on Nov. 4, 2014, the disclosures of which are incorporated herein by reference.

### TECHNICAL FIELD

The present disclosure relates to a sensing system including a surface acoustic wave (SAW) sensor.

### BACKGROUND ART

A known type of SAW devices includes an interdigital transducer formed on a piezoelectric substrate for generating an SAW. A change in a physical quantity, such as temperature and force, of a subject being measured brings a change in the spacing of an interdigital transducer, the propagation speed of the SAW, and the like and thus a change in the electrical characteristics of an SAW device. An SAW sensing system measures a physical quantity on the basis of detection of such a change in electrical characteristic.

For example, one type of SAW sensing systems is provided with an SAW resonator that includes an interdigital transducer and reflectors, which are disposed on both sides of the interdigital transducer, on a piezoelectric material. This type of SAW sensing systems calculates a physical quantity of a subject to be measured on the basis of the amount of change in resonance frequency of the SAW resonator. This scheme is achieved in such a manner that a modulated signal resulting from frequency modulation of a reference oscillator signal is input to the sensor device and a change in the frequency at which the SAW resonator absorbs the energy the most is detected. In another scheme, an oscillator circuit including an SAW resonator is provided, and the amount of change in its oscillating frequency is read.

Another type of SAW sensors is provided with a transversal SAW delay device that includes an input interdigital transducer and an output interdigital transducer on a piezoelectric material. This type of SAW sensors calculates a physical quantity of a subject to be measured on the basis of the difference in strength of input/output signals, delay time, and the amount of change in phase of the transversal SAW delay device. This type of SAW sensing systems achieves similar detection when a reflective SAW delay device is employed that includes an input/output interdigital transducer and a reflector disposed in a remote location.

### PATENT LITERATURE

Patent Literature 1: JP H5-506504 A

### SUMMARY

The present inventor has been studying a sensing system in which an SAW sensor that includes, for example, an SAW resonator, a transversal SAW delay device, or a reflective SAW delay device is installed on a crankshaft of a vehicle engine. This system detects the amount of change in resonance frequency or the amount of change in phase angle of a delay signal or a reflection signal to determine a torque.

Use of such a sensing system allows conversion of the amount of deformation in the SAW device due to the torque into an electrical characteristic, such as the amount of change in resonance frequency or the amount of change in phase angle of a delay signal or a reflection signal. Hence, it is conceivable that the torque can be calculated on the basis of the amount of change in this electrical characteristic. It should be noted, though, that a crankshaft may exhibit a deflection resulting from a force perpendicular to the shaft, in addition to a deformation resulting from the torque. Accordingly, an electrical characteristic of an SAW device includes a signal component resulting from the torque and a signal component resulting from the deflection in the shaft superimposed thereon. Furthermore, deformation in the SAW device and an SAW sonic change due to temperature are also superimposed as a signal component resulting from temperature. If their effects are so significant that it is not negligible, it is necessary to provide an SAW device for detecting deflection in the shaft and an SAW device for detecting temperature separately as a means for separating signal components and perform correcting processing to subtract signal components resulting from the deflection and temperature.

The size and number of SAW devices, however, may be restricted depending on the installation environment of an SAW sensor. Such restrictions may prevent installation of many devices in some cases. Additionally, when an SAW sensor including many transversal SAW delay devices or many reflective SAW delay devices is used, distinction of sensor signals may be difficult. An SAW delay device made from lithium niobate is discussed here as an example. This device has a size equal to or smaller than 2 [mm]×4 [mm] and includes 40 interdigital transducers and 40 reflectors. FIG. 1 is a graph of characteristics TS1, TS2, and TS3 with delay time varied by adjusting the length of a propagation line. An attempt to identify a condition under which reflection signals of many (three, for example) SAW devices do not overlap with each other may prove difficult, presenting degradation in ease of design. In the case of an SAW sensor including an SAW resonator, a frequency range that needs to be scanned may be increased in view of distinguishing sensor signals in accordance with the frequency of the SAW resonator, which may directly lead to degradation in response as a sensor system.

An object of the present disclosure is to provide a sensing system that enables calculation of a physical quantity with a surface acoustic wave sensor including surface acoustic wave devices, which are minimized in number, without the need to add surface acoustic wave devices in such a manner that the number of the devices corresponds to the number of physical quantities to be corrected.

A sensing system according to an aspect of the present disclosure includes: a surface acoustic wave sensor having a first surface acoustic wave device and a second surface acoustic wave device; a sensing apparatus that is communicably connected to the surface acoustic wave sensor, and that detects an electrical characteristic of the first surface acoustic wave device and an electrical characteristic of the second surface acoustic wave device of the surface acoustic wave sensor; and a control apparatus that calculates at least one physical quantity, which acts on one of a target to which the surface acoustic wave sensor is attached and the surface acoustic wave sensor, based on a sensor signal detected by the sensing apparatus. In addition, the at least one physical quantity includes a first physical quantity, a second physical quantity, and a third physical quantity. Moreover, a ratio of a sensitivity of the first physical quantity of the first surface acoustic wave device to a sensitivity of the first physical quantity of the second surface acoustic wave device is different from a ratio of a sensitivity of the second physical quantity of the first surface acoustic wave device to a sensitivity of the second physical quantity of the second surface acoustic wave device; and the third physical quantity is removable from the at least one physical quantity by performing an averaging process. Furthermore, the control apparatus calculates the second physical quantity by removing the first physical quantity from the at least one physical quantity based on a result of a comparison operation between a sensor signal from the first surface acoustic wave device and a sensor signal from the second surface acoustic wave device, and by performing the averaging process to regard the third physical quantity as a predetermined value and to remove the third physical quantity from the at least one physical quantity.

When a surface acoustic wave sensor including two surface acoustic wave devices is attached to a subject to be measured, a configuration as described above can calculate one of physical quantities included in a characteristic of each of the surface acoustic wave devices by performing averaging on information of the physical quantities. In other words, a sensing system according to the present disclosure enables calculation of a physical quantity with a surface acoustic wave sensor including surface acoustic wave devices, which are minimized in number, without the need to add surface acoustic wave devices in such a manner that the number of the devices corresponds to the number of physical quantities to be corrected.

### BRIEF DESCRIPTION OF DRAWINGS

The above and other objects, features and advantages of the present disclosure will become more apparent from the following detailed description made with reference to the accompanying drawings. In the drawings:

FIG. 1 is a graph of a signal strength—time characteristic of a reflected signal of an SAW device;

FIG. 2 is a block diagram schematically illustrating an exemplary electrical configuration of a sensing system including a reflective SAW delay device according to a first embodiment;

FIG. 3A is a structure diagram schematically illustrating an SAW sensor;

FIG. 3B is a longitudinal sectional structure diagram schematically illustrating the SAW sensor along line A-A in FIG. 3A;

FIG. 4 is a flowchart schematically illustrating an exemplary processing operation of the sensing system;

FIG. 5 is a flowchart schematically illustrating an exemplary processing operation of a sensing system according to a second embodiment;

FIG. 6 is a flowchart schematically illustrating an exemplary processing operation of a sensing system according to a third embodiment;

FIG. 7 is a perspective view schematically illustrating a configuration of a sensing system according to a fourth embodiment;

FIG. 8 is a perspective view schematically illustrating a configuration of a sensing system according to a fifth embodiment;

FIG. 9 is a block diagram schematically illustrating a configuration of a sensing system of a resonator type according to a sixth embodiment;

FIG. 10 is a sectional view schematically illustrating a layout of an SAW sensor according to a seventh embodiment;

FIG. 11 is a sectional view schematically illustrating a layout of an SAW sensor according to an eighth embodiment;

FIG. 12 is a sectional view schematically illustrating a layout of an SAW sensor according to a ninth embodiment;

FIG. 13 is a schematic diagram illustrating a layout of an SAW sensor according to a tenth embodiment;

FIG. 14 is a schematic diagram illustrating a layout of an SAW sensor according to an eleventh embodiment;

FIG. 15A is a schematic diagram illustrating a layout of an SAW sensor according to a twelfth embodiment;

FIG. 15B is a sectional view schematically illustrating a first SAW device according to the twelfth embodiment in a signal propagation direction;

FIG. 15C is a sectional view schematically illustrating a second SAW device according to the twelfth embodiment in a signal propagation direction; and

FIG. 16 is a flowchart schematically illustrating an exemplary processing operation of a sensing system according to a thirteenth embodiment.

### DETAILED DESCRIPTION

Some embodiments of the sensing system will now be described with reference to the drawings. In the embodiments described below, components that operate in identical or similar manners are designated with identical or similar symbols, and their description may be omitted as necessary.

### First Embodiment

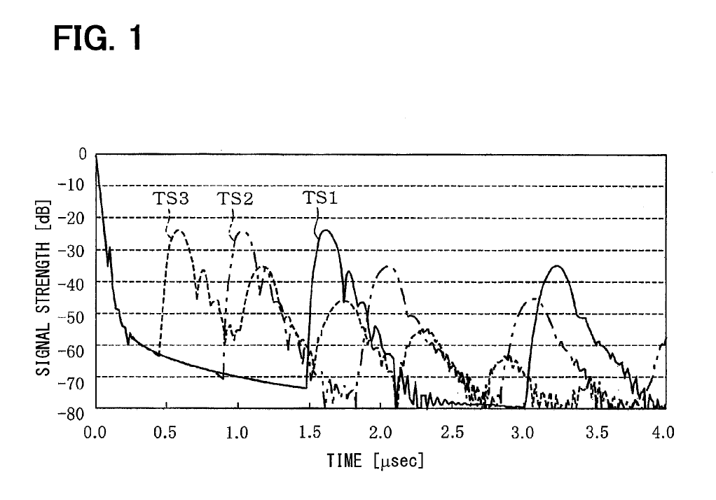

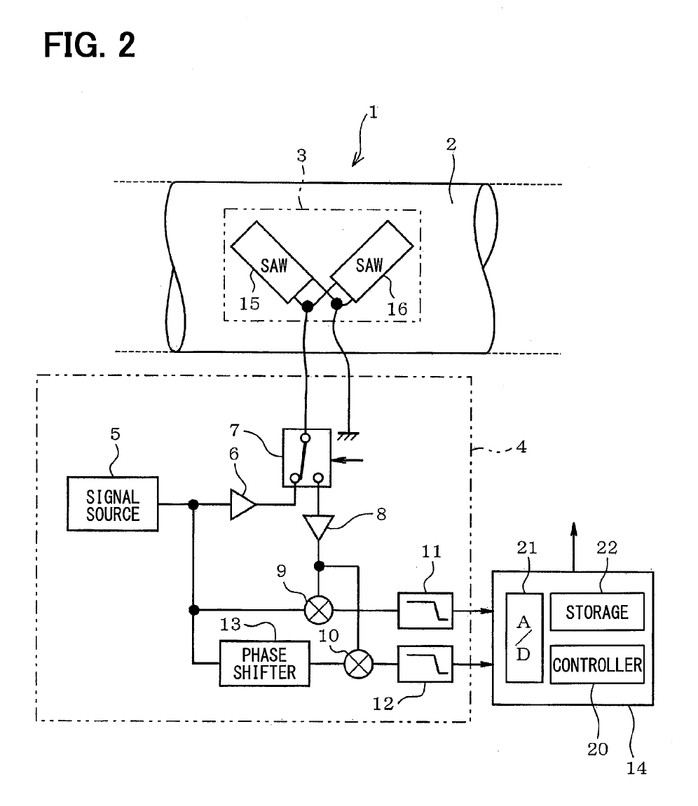

FIGS. 1 to 4 are diagrams for describing a first embodiment. An exemplary configuration of a sensing system including a reflective SAW delay device is taken as an example to describe the first embodiment. With reference to FIG. 2, a sensing system 1 is disposed, for example, on and in proximity to a crankshaft (which corresponds to a subject to be measured) 2 in an engine (not shown). The sensing system 1 includes an SAW sensor 3, which is disposed, for example, on a side surface of the crankshaft 2 so as to deform in accordance with a torque of the crankshaft 2, and a sensing apparatus 4, which is connected to the SAW sensor 3.

The sensing apparatus 4 includes a signal source 5, which outputs a sinusoidal signal, a transmission amplifier 6, a switch 7 for switching between transmission and reception, a reception amplifier 8, first and second mixers 9 and 10, low-pass filters 11 and 12, and a phase shifter 13. The sensing apparatus 4 is connected to a control apparatus 14. The signal source 5 outputs a sinusoidal signal with a predefined frequency set to approximately 200 [MHz] (for example, 204 MHz ±4 MHz).

Upon reception of the sinusoidal signal from the signal source 5, the transmission amplifier 6 amplifies the sinusoidal signal and outputs a resultant signal to the switch 7. The switch 7 is switched between transmission and reception in accordance with a control signal from the control apparatus 14. When the switch 7 is switched to the transmission amplifier 6, the sinusoidal signal amplified by the transmission amplifier 6 is output to the SAW sensor 3.

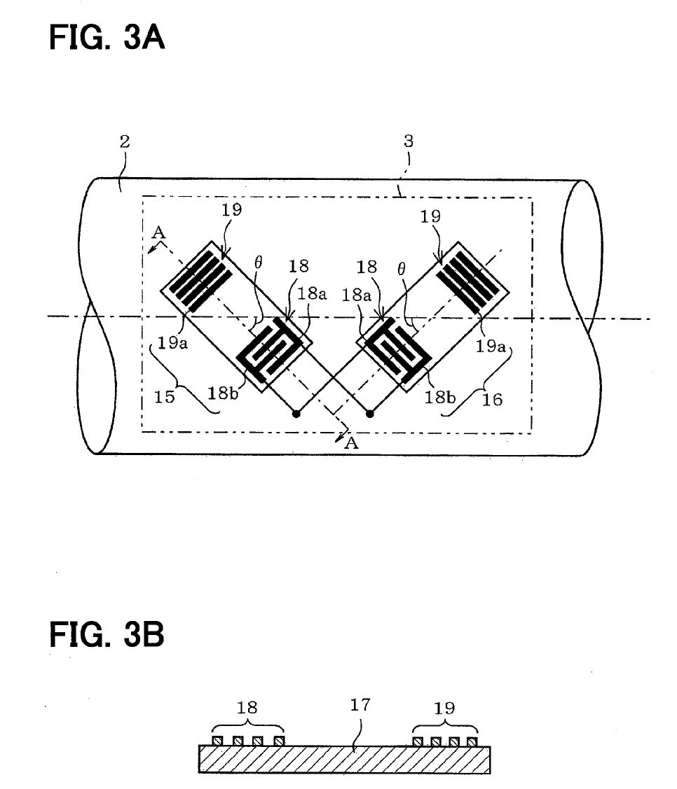

The SAW sensor 3 includes a first SAW device 15 and a second SAW device 16, which are connected in parallel. As seen in a schematic exemplary configuration illustrated in FIGS. 3A and 3B, the first and second SAW devices 15 and 16 each include a piezoelectric substrate 17, an interdigital transducer 18 disposed on the piezoelectric substrate 17 for generating an SAW, and a reflector 19 spaced apart from the interdigital transducer 18. The piezoelectric substrate 17 is made from, for example, lithium niobate. As illustrated in FIG. 3B, the interdigital transducer 18 and the reflector 19, which are made from, for example, aluminum, are disposed on one end and on the other end, respectively, of the substrate 17.

The interdigital transducer 18 includes two electrodes 18a and 18b each having a few tens (20, for example) of strips that are arranged with a predefined pitch (9.6 μM, for example). The two electrodes 18a and 18b of the interdigital transducer 18 of each of the first and second SAW devices 15 and 16 are used in a pair. The electrode 18b is grounded, and the electrode 18a is connected to the sensing apparatus 4.

The reflector 19 is made from, for example, aluminum, which is the same material as the interdigital transducer 18. The reflector 19 includes a predefined number of (40, for example) electrodes 19a that extend in a direction perpendicular to the traveling direction of the SAW and are arranged with a predefined pitch (9.6 μM, for example).

The sensing apparatus 4 can generate an SAW along the piezoelectric substrate 17 illustrated in FIG. 3B when a signal at the predefined frequency is input to the interdigital transducer 18 from the signal source 5 through the transmission amplifier 6 and the switch 7 as illustrated in FIG. 2. The generated SAW travels from the interdigital transducer 18 to the reflector 19. The SAW is then reflected by the reflector 19 and returns to the interdigital transducer 18. In the present embodiment, the distance from the interdigital transducer 18 to the reflector 19 is set to approximately a few millimeters (3 mm, for example).

As described above, the switch 7 illustrated in FIG. 2 is switched between the transmission and the reception in accordance with a control signal from the control apparatus 14. In the present embodiment, the control apparatus 14 switches the switch 7 to the reception amplifier 8 during propagation of a sinusoidal signal in the SAW sensor 3. A reflected signal having propagated in the SAW sensor 3 is transferred to the reception amplifier 8. The reception amplifier 8 amplifies the transferred signal and outputs an amplified signal to the first and second mixers 9 and 10.

The phase shifter 13 is disposed between the signal source 5 and the second mixer 10. The phase shifter 13 shifts the phase of a sinusoidal signal generated by the signal source 5 by a predefined angle and outputs a resultant signal to the second mixer 10. In the present embodiment, the phase shifter 13 shifts the phase of a sinusoidal signal by, for example, 90 degrees and outputs a resultant signal to the second mixer 10.

The first mixer 9, which is configured with, for example, a passive mixer, receives a sinusoidal signal directly from the signal source 5, mixes the input signal with an amplified signal from the reception amplifier 8, and outputs a resultant signal to the control apparatus 14 through the low-pass filter 11. The second mixer 10, which is configured with, for example, a passive mixer, receives a sinusoidal signal generated by the signal source 5 and having its phase shifted by 90 degrees by the phase shifter 13, mixes the input signal with an amplified signal from the reception amplifier 8, and outputs a resultant signal to the control apparatus 14 through the low-pass filter 12.

The control apparatus 14 can be configured with, for example, a microcomputer. The control apparatus 14 includes a controller 20, which is a principal unit for control, an A/D converter 21, and a storage 22. The controller 20 causes the A/D converter 21 to perform analog-to-digital conversion on a signal from the first mixer 9 through the low-pass filter 11 and causes the storage 22 to store resultant data. The controller 20 also causes the A/D converter 21 to perform the analog-to-digital conversion on a signal from the second mixer 10 through the low-pass filter 12 and causes the storage 22 to store resultant data. The control apparatus 14 calculates a phase angle θa of a reflected signal from the first SAW device 15 and a phase angle θb of a reflected signal from the second SAW device 16 on the basis of the converted digital data stored in the storage 22, that is, on the basis of sensor signals from the SAW sensor 3.

The SAW sensor 3 is installed in such a manner that the first and second SAW devices 15 and 16 deform in accordance with a torque of the crankshaft 2. As a result, the phase angle θa of a reflected signal from the first SAW device 15 and the phase angle θb of a reflected signal from the second SAW device 16 change in proportion to the amount of change in torque To applied to the crankshaft 2. This enables calculation of the torque To on the basis of the phase angle θa or θb. It should be noted here that the phase angles θa and θb also change with a physical quantity that is not a subject being measured, such as environmental temperature of the crankshaft of an engine and deflection in the crankshaft.

If they change linearly in accordance with each of, for example, the torque, temperature, and deflection, an amount of change Δθa in reflection phase angle θa of signals from the first SAW device 15 and an amount of change Δθb in reflection phase angle θb of signals from the second SAW device 16, which can be obtained from the sensor signals, satisfy the following relationships, respectively.

Δθa=Fa×To+Ga×Te+Ha×Tw (1aa)

Δθb=Fb×To+Gb×Te+Hb×Tw (1ba)

Here, Fa and Fb represent sensitivities (factors) to the torque, Ga and Gb represent sensitivities (factors) to the temperature, Ha and Hb represent sensitivities (factors) to the deflection, To represents the torque (a physical quantity), Te represents the temperature (a physical quantity), Tw represents the deflection (a physical quantity), and Δθa and Δθb represent the amounts of change in θa and θb from the θa and θb when To=0, Te=0, and Tw=0.

Each of the sensitivities (factors) in the sensing system 1, namely, Fa, Fb, Ga, Gb, Ha, and Hb, needs to be obtained in advance based on experiment or simulation because of their variability with the design of the SAW devices and the configuration and installation environment of the SAW sensor 3. These sensitivities (factors) are stored in the storage 22 in the control apparatus 14.

The torque To element is removed from expressions (1aa) and (1ba) on the basis of the relationships.

Δθb−Δθa×(Fb/Fa)={Gb−Ga×(Fb/Fa)}×Te+{Hb−Ha×(Fb/Fa)}×Tw (2)

When averaging is performed in a time for one rotation of the crankshaft 2 or a time sufficiently longer than the time for one rotation of the crankshaft 2 (equal to or longer than 500 msec, for example) in expression (2), the physical quantity of the deflection Tw of the crankshaft 2 can be removed. The deflection Tw of the crankshaft 2 results from the weight of the crankshaft 2 and eccentricity of the shaft connection. Thus, an average value of the deflection Tw for one shaft rotation can be assumed as a constant value. A predetermined value of the deflection Tw can be obtained in advance through experiment or simulation, in which case, the physical quantity of the deflection Tw can be removed. Then, conversion as in expression (3) below can be achieved.

ave{Δθb−Δθa×(Fb/Fa)}={Gb−Ga×(Fb/Fa)}×ave{Te}+constant (3)

Here, the constant in expression (3) can be subtracted from expression (3). After the subtraction, the expression is expanded with the temperature Te in the left side of the expression.

ave{Te}=ave[{Δθb−Δθa×(Fb/Fa)}/{Gb−Ga×(Fb/Fa)}] (4)

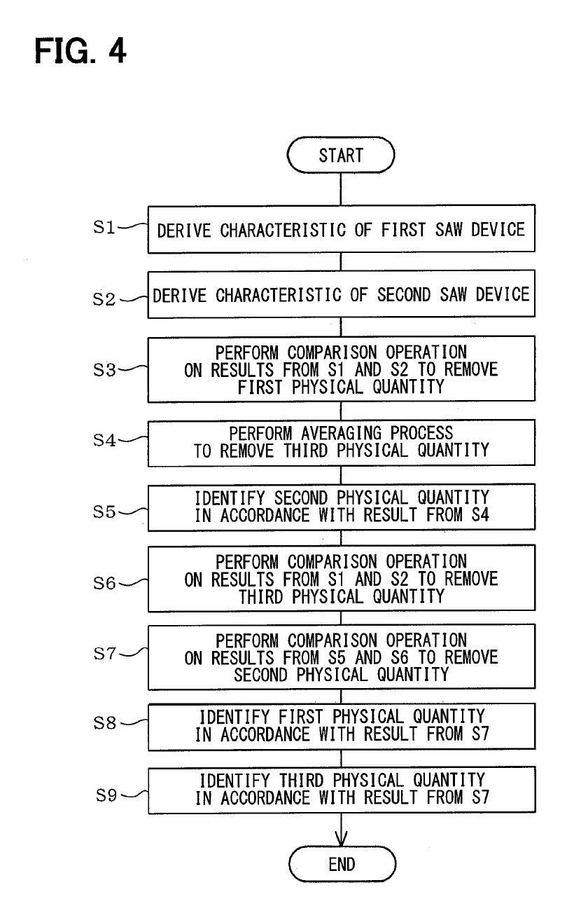

Then, the physical quantity of the deflection Tw is removed from expressions (1aa) and (1ba) described above. (This corresponds to S6 in FIG. 4 to be described hereinafter.)

{θb−Δθa×(Hb/Ha)}={Fb−Fa×(Hb/Ha)}×To+{Gb−Ga×(Hb/Ha)}×Te (5)

Then, ave{Te} obtained in expression (4) is substituted into the temperature Te in expression (5). (This corresponds to S7 in FIG. 4 to be described hereinafter.)

{θb−Δθa×(Hb/Ha)}={Fb−Fa×(Hb/Ha)×To+{Gb−Ga×(Hb/Ha)/{Gb−Ga×(Fb/Fa)}×ave[{Δθb×(Fb/Fa)}] (6)

Here, the ratio of the sensitivities (factors) Fb/Fa is different from the ratio of the sensitivities (factors) Hb/Ha. The ratio of the sensitivities (factors) Gb/Ga may be different from or equal to the ratio of the sensitivities (factors) Hb/Ha. The torque To is calculated based on expression (6). (This corresponds to S8 in FIG. 4 to be described hereinafter.)

To=[{Δθb−Δθa×(Hb/Ha)}−{Gb−Ga×(Hb/Ha)}/{Gb−Ga×(Fb/Fa)}×ave[{Δθb−Δθa×(Fb/Fa)}]/{Fb−Fa×(Hb/Ha)} (7)

In this manner, calculating the phase angles θa and θb enables calculation of the torque To. The deflection Tw can be also calculated as necessary as indicated in expression (8).

Tw=[Δθb−Δθa×(Fb/Fa)−ave{Δθb−Δθa×(Fb/Fa)}]/{Hb−Ha×(Fb/Fa)} (8)

When this method of calculation is employed and the averaging is performed in, for example, a time for one shaft rotation or a time sufficiently longer than the time for one shaft rotation (equal to or longer than 500 [msec], for example) as described above, an error can be minimized during removal of the constant and thereby an accurate result of calculation can be obtained.

Assuming a condition that the rate of change of the temperature Te is sufficiently lower than those of the torque To and the deflection Tw yields an accurate result of calculation, although the response speed of the temperature Te is slowed down.

For example, the present inventor and others have verified that, when the crankshaft 2 of a vehicle engine is the subject to be measured, the rate of change of the temperature Te is approximately 2[° C.] per second at an assumption of 1200 [rpm], although the rate of change of the temperature Te is dependent also on the structure and thickness of the crankshaft 2 and the heat source. Here, since one rotation of the crankshaft 2 takes 50 [msec], the temperature difference achieved in the elapsed time of 50 [msec] is 2[° C./sec]×50 [msec]=0.1[° C.]. The temperature change of 0.1[° C.], which takes place gradually during one rotation of the crankshaft 2, is an increase of 0.05[° C.] in terms of time average for a past one rotation. Thus, the difference between a time average value of temperature in 50 [msec] (a temperature increase of 0.05[° C.]) and a realistic, actual temperature in 50 [msec] (a temperature increase of 0.1[° C.]) falls within approximately 0.05[° C].

This indicates that this method of calculation is suitably employed because the speed at which the crankshaft 2 makes one rotation is sufficiently higher than the rate of change of the temperature of crankshaft 2 of a vehicle engine, which has relatively large heat capacity. Additionally, the averaging slows down the response speed of only the temperature Te component and does not reduce the response speeds of the torque To component and the deflection Tw component. Hence, this method of calculation is further suitable for physical quantities that satisfy this relationship.

With consideration given to such an engineering idea, different physical quantities (the temperature Te and the torque To, for example) can be calculated when the control apparatus 14 performs processing as described below. The processing will now be described with reference to FIG. 4.

The controller 20 of the control apparatus 14 derives a characteristic of the first SAW device 15 (S1 in FIG. 4). In the present embodiment, the controller 20 calculates the phase angle θa of a reflected signal from the first SAW device 15 of the SAW sensor 3. The torque sensitivity (factor) Fa, the temperature sensitivity (factor) Ga, and the deflection sensitivity (factor) Ha are determined in advance. Thus, the calculation here corresponds to deriving the relationship of expression (1aa).

Then, the controller 20 derives a characteristic of the second SAW device 16 (S2 in FIG. 4). In the present embodiment, the controller 20 calculates the phase angle θb of a reflected signal from the second SAW device 16 of the SAW sensor 3. The torque sensitivity (factor) Fb, the temperature sensitivity (factor) Gb, and the deflection sensitivity (factor) Hb are determined in advance. Thus, the calculation here corresponds to deriving the relationship of expression (1ba).

Then, the controller 20 performs a comparison operation on the resultant characteristics to remove a first physical quantity (S3 in FIG. 4). In the present embodiment, the controller 20 uses the torque To as the first physical quantity and removes the torque To. In the present embodiment, this corresponds to deriving the relationship of expression (2).

Then, the controller 20 performs averaging on the result of the processing described above to remove a third physical quantity (S4 in FIG. 4). In the present embodiment, this corresponds to the controller 20 of the sensing apparatus 4 using the deflection Tw as the third physical quantity and deriving the relationship of expression (3) by performing the averaging for, for example, one shaft rotation for the deflection Tw.

Then, the controller 20 identifies a second physical quantity in accordance with the result of the processing described above (S5 in FIG. 4). In the present embodiment, this corresponds to the controller 20 using the temperature Te as the second physical quantity and identifying the temperature Te on the basis of the relationship of expression (4).

Then, the controller 20 performs a comparison operation on the results from steps S1 and S2 to remove the third physical quantity (S6 in FIG. 4). In the present embodiment, this removal processing corresponds to the controller 20 removing the parameter related to the deflection Tw and calculating expression (5) having the parameters of the torque To and the temperature Te.

Then, the controller 20 performs a comparison operation on the results from steps S5 and S6 to remove the parameter of the second physical quantity (S7 in FIG. 4). In the present embodiment, this removal processing corresponds to the controller 20 substituting expression (4) into the temperature Te in expression (5) to remove the temperature Te as in the calculation of expression (6).

Then, the controller 20 identifies the first physical quantity in accordance with the result of step S7 (S8 in FIG. 4). In the present embodiment, this removal processing corresponds to the controller 20 calculating the torque To as in expression (7) on the basis of expression (6).

Then, the controller 20 identifies the third physical quantity in accordance with the result of step S7 (S9 in FIG. 4). In the present embodiment, this removal processing corresponds to the controller 20 of the sensing apparatus 4 calculating the deflection Tw on the basis of expression (8). The first to third physical quantities can be all calculated in the manner described above.

The present embodiment enables the removal of effects of the first and third physical quantities from the electrical characteristics of the first and second SAW devices 15 and 16 and thereby the calculation and identification of the temperature Te, which is the second physical quantity. Then, the present embodiment also enables the calculation of the torque To and the deflection Tw, which are the first and third physical quantities, to identify all the physical quantities.

### Second Embodiment

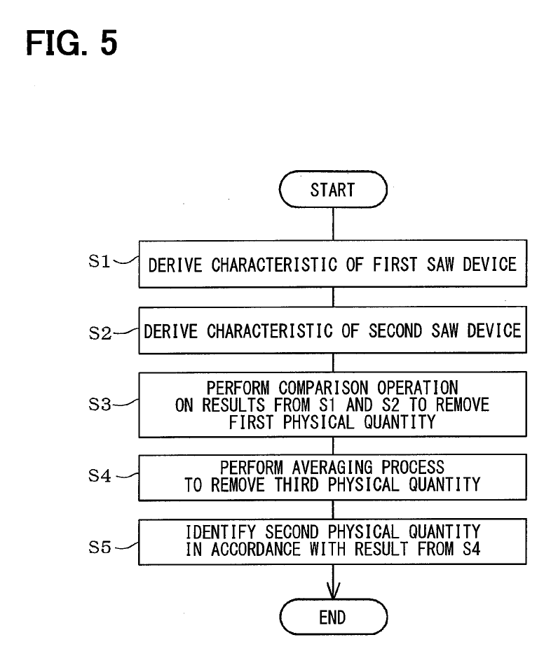

FIG. 5 is a diagram for describing a second embodiment. In the second embodiment, only a needed physical quantity is calculated and identified. As illustrated in FIG. 5, a controller 20 may perform processing in steps S1 to S5 described in the first embodiment and omit the other processing (S6 to S9 in FIG. 4) so as to identify only the second physical quantity (the temperature Te in the first embodiment). The processing to identify the first and third physical quantities (the torque To and the deflection Tw, respectively, in the first embodiment) may be omitted.

### Third Embodiment

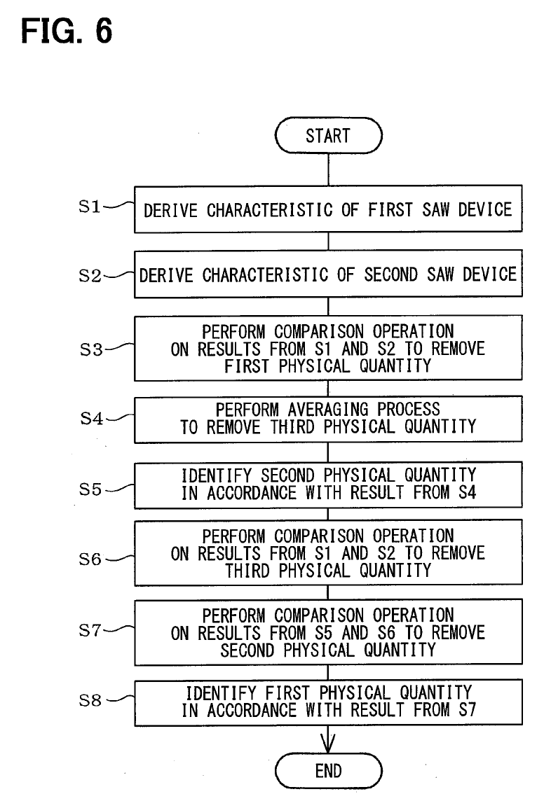

FIG. 6 is a diagram for describing a third embodiment. In the third embodiment, only a needed physical quantity is calculated and identified.

As in an example in FIG. 6 for describing the third embodiment, a controller 20 may perform processing in steps S1 to S8 described in the first embodiment and omit the other processing so as to perform the processing up to the identification of the first physical quantity (the torque To in the first embodiment). The processing to identify the third physical quantity (the deflection Tw in the first embodiment) may be omitted.

### Fourth Embodiment

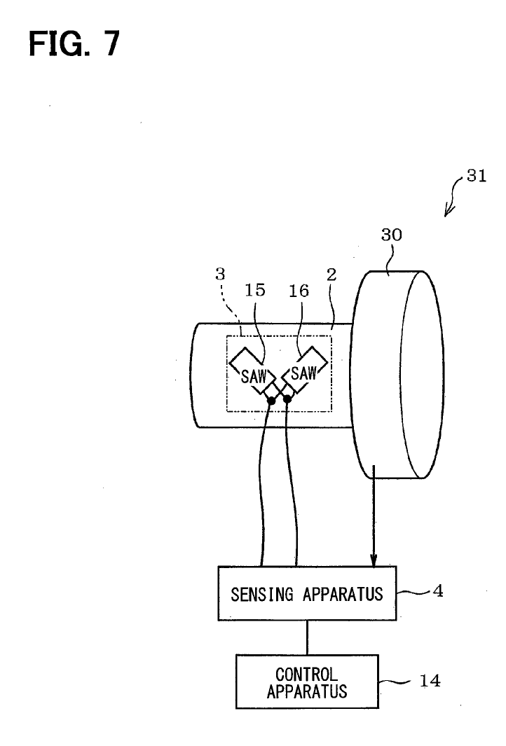

FIG. 7 is a diagram for describing a fourth embodiment. In the fourth embodiment, a shaft rotary angle sensor 30 is used as a number-of-times setting sensor for calculating the number of times of averaging when the parameter of the third physical quantity is removed.

A sensing system 31 includes the shaft rotary angle sensor 30, which is disposed on the crankshaft 2, in addition to the components of the sensing system 1 described in the foregoing embodiments. With the sensing system 31, a controller 20 in the control apparatus 14 can obtain a rotary angle of the shaft on the basis of a sensor signal from the shaft rotary angle sensor 30.

The controller 20 may remove the parameter of the third physical quantity (the deflection Tw, for example) by performing the averaging in step S4 described in FIGS. 4, 5, and 6 in the first to third embodiments on the basis of a sensor signal obtained in real time from the shaft rotary angle sensor 30.

In this manner, the averaging can be performed in response to the rotary angle of the crankshaft 2, which keeps changing, correction can be performed in accordance with the parameter of the third physical quantity, which changes in real time, and the response speed of the second physical quantity (and those of the first physical quantity and the third physical quantity as required) can be improved to a certain degree. The shaft rotary angle sensor 30 may be newly provided. Alternatively, an existing sensor provided for other purposes may be used as the shaft rotary angle sensor 30. For example, a crank angle sensor already provided for use in a vehicle engine may be used as the shaft rotary angle sensor 30.

### Fifth Embodiment

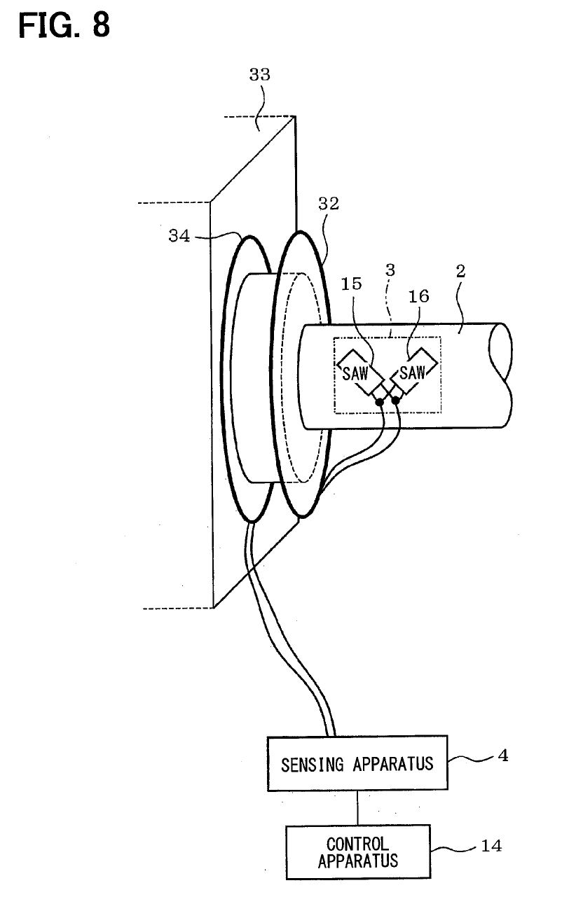

FIG. 8 is a diagram for describing a fifth embodiment. In the fifth embodiment, a sensing apparatus 4 and an SAW sensor 3 communicate with each other via antennas 32 and 34.

A crankshaft 2 is rotatably supported by an installation body 33. The antenna 34 is fixedly attached to the installation body 33. The SAW sensor 3 and the antenna 32 are attached on the crankshaft 2. The antenna 32 is connected to first and second SAW devices 15 and 16 of the SAW sensor 3 through a signal line. The antennas 32 and 34 are configured with, for example, loop antennas and oriented in such a manner that their loop apertures face each other.

Although the antenna 32, which is attached to the crankshaft 2, is rotated as the crankshaft 2 rotates, the loop apertures of the antennas 32 and 34 keep facing each other during the rotation. Thus, the sensing apparatus 4 and the SAW sensor 3 can wirelessly communicate signals with each other via the antennas 32 and 34.

To describe it from an electrical standpoint, a transfer characteristic of the antennas 32 and 34, which are disposed between the SAW sensor 3 and a switch 7 illustrated in FIG. 2, may vary with factors such as the installation condition, for example, on the crankshaft 2 (the gradients of the loop apertures of the antennas 32 and 34 in facing axis directions), impedance matching between the antennas 32 and 34 and the SAW sensor 3 or the switch 7, and impedance matching between the SAW devices 15 and 16. In other words, the transfer characteristic of the antennas 32 and 34 may vary with a change in relative position of the antennas 32 and 34 as the crankshaft 2 rotates.

In place of the parameter of the deflection Tw as the third physical quantity described in the foregoing embodiments, the transfer characteristic of the antennas 32 and 34 may be considered as the third physical quantity. On such an assumption, the amounts of change Δθa and Δθb of the phase angles θa and θb obtained from sensor signals of the SAW sensor satisfy the following relationships, respectively.

Δθa=Fa×To+Ga×Te+Ia×Ph (1c)

Δθb=Fb×To+Gb×Te+Ib×Ph . . . (1d), where Ia and Ib are parameters (dimensionless) indicative of the influence (sensitivities) of the use of the antennas 32 and 34, and Ph indicates a phase change characteristic ([deg]) of the antennas 32 and 34.

In this manner, equations using a mutual characteristic of the antennas 32 and 34 can be approximated, and, thus, relational expressions similar to expression (1aa) and expression (1ba) described in the first embodiment can be provided. This enables use of the phase change characteristic Ph of the antennas 32 and 34 as the third physical quantity. The phase change characteristic Ph of the antennas 32 and 34 changes periodically because the relative positions of the antennas 32 and 34 change as the crankshaft 2 rotates, as described above.

Accordingly, the phase change characteristic Ph of the antennas 32 and 34 is a parameter that can be processed by averaging for, for example, one rotation of the crankshaft 2. Expansion of mathematical expressions similar to that of expressions (1aa) to (7) can be performed by using the phase change characteristic Ph in place of the parameter of the deflection Tw, and, thus, the method described in the first embodiment enables the calculation of all the first to third physical quantities. The first and third physical quantities may be calculated as required also in the present embodiment.

### Sixth Embodiment

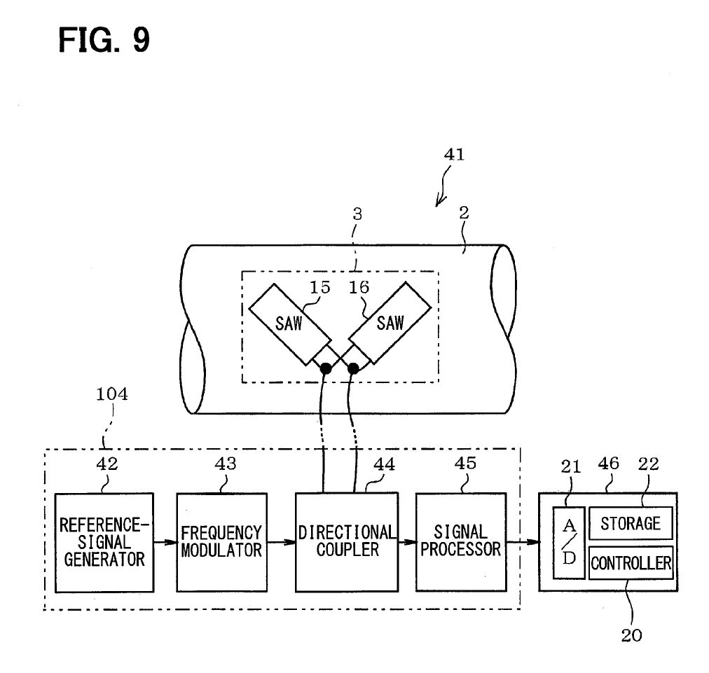

FIG. 9 is a diagram for describing a sixth embodiment. In the sixth embodiment, an SAW sensing system 41 of an SAW resonator type is described. The SAW sensing system 41 of the SAW resonator type modulates and sweeps the frequency of a signal to be input to first and second SAW devices 15 and 16 in a predefined frequency range, detects a resonance frequency with which the first and second SAW devices 15 and 16 each absorb the input energy of the input signal, and calculates different physical quantities on the basis of the resonance frequencies.

In the present embodiment, a case in which the SAW sensing system 41 of the SAW resonator type is used as a sensor head of a torque sensor will be described. An SAW sensor 3 of the sensing system 41 is attached on a crankshaft 2 so that, when the crankshaft 2 is strained, the SAW sensor 3 is also strained in accordance with the strain in the shaft. This results in a change in resonance frequency of the SAW sensor 3.

The sensing system 41 according to the present embodiment is configured to detect the resonance frequencies for detecting the effect of the amount of strain in the crankshaft 2. Here, the torque To is proportional to the amount of strain in the crankshaft 2, the amount of strain in the crankshaft 2 is proportional to the amount of strain in the SAW sensor 3, and the amount of strain in the SAW sensor 3 is proportional to the amount of change in resonance frequency of the SAW sensor 3. Thus, the torque To can be calculated by acquiring the amount of change in resonance frequency of the SAW sensor 3.

The sensing system 41 illustrated in FIG. 9 is provided with a sensing apparatus 104 including a reference-signal generator 42, a frequency modulator 43, a directional coupler 44, and a signal processor 45, all of which are connected. A control apparatus 46 is disposed downstream of the signal processor 45 and connected thereto.

The reference-signal generator 42 transmits a reference signal with a predefined carrier frequency (200 [MHz], for example). The frequency modulator 43 performs frequency modulation on the reference signal and, while sweeping a resultant frequency in a frequency range (195 [MHz] to 205 [MHz], for example), inputs the signal as an excitation signal to the SAW sensor 3 through the directional coupler 44. When the frequency of the excitation signal does not agree with a resonance frequency, the SAW sensor 3 reflects the signal to the circuit without absorbing the energy. The reflected excitation signal is output to the signal processor 45 through the directional coupler 44. The signal processor 45 detects the signal strength of the output signal. Since the SAW sensor 3 is attached on the crankshaft 2, the amount of strain changes with the amount of torque applied to the crankshaft 2, and the resonance frequency changes with the amount of strain. When the frequency of the excitation signal approximately agrees with the resonance frequency, the excitation signal is absorbed, and, accordingly, the signal output to the signal processor 45 is weakened. The signal processor 45 detects the strength of this signal and outputs the detected information to the control apparatus 46.

As in the case with the foregoing embodiments, the control apparatus 46 includes a controller 20, an A/D converter 21, and a storage 22. The A/D converter 21 performs the analog-to-digital conversion on the output signal from the signal processor 45, and the storage 22 stores the resultant data.

The first and second SAW devices 15 and 16 have mutually different internal structures and thus have mutually different resonance frequencies. The controller 20 can use the difference between the obtained resonance frequencies to distinguish the first SAW device 15 from the second SAW device 16.

The techniques described in the embodiments described above and below can be employed for the sensing system 41 of the resonator type as in the present embodiment.

### Seventh Embodiment

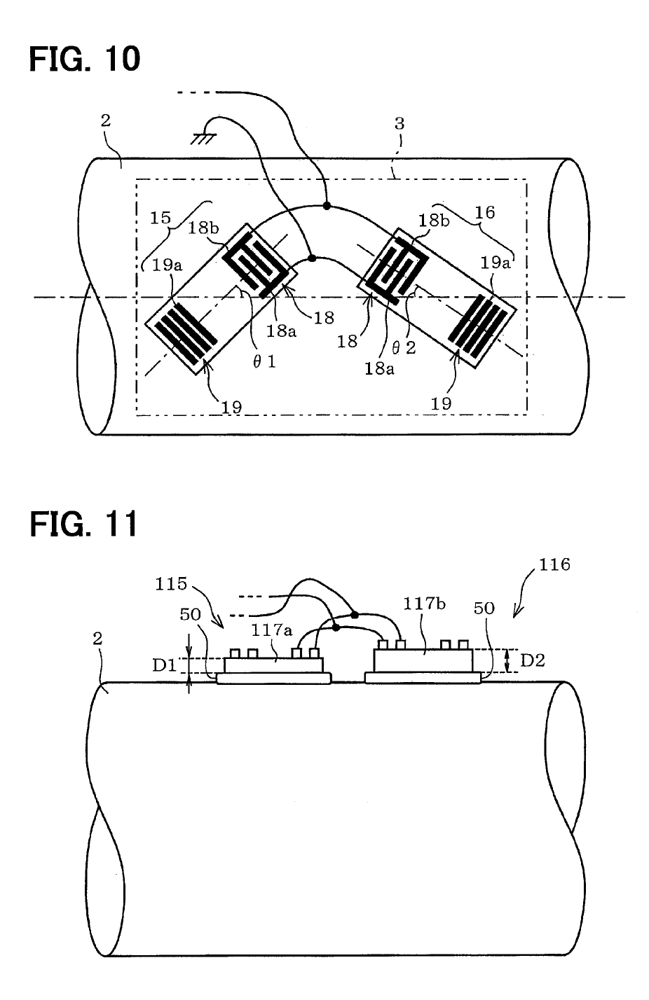

FIG. 10 is a diagram for describing a seventh embodiment. The seventh embodiment is characterized in that sensitivities (factors) to one or more predefined physical quantities are adjusted in accordance with angles at which SAW devices 15 and 16 are attached.

As illustrated in FIG. 10, the first SAW device 15 is installed in such a manner that the propagation direction of its SAW is at an angle φ1 with respect to the central axis of a crankshaft 2. The second SAW device 16 is installed in such a manner that the propagation direction and reflection direction of its SAW are at an angle φ2, which is different from φ1, with respect to the central axis of the crankshaft 2.

The first and second SAW devices 15 and 16, which are installed at such mutually different angles, receive mutually different forces when the crankshaft 2 is rotated about its central axis. Such a difference in force results in changes to sensitivities of the phase angles θa and θb of the first and second SAW devices 15 and 16, which are dependent on a physical quantity of, for example, the deflection Tw and obtained from the sensor signals. Sensitivities (factors) corresponding to one or more predefined physical quantities (the deflection Tw, for example) can be changed and thus adjusted with the installation angles set as described above.

### Eighth Embodiment

FIG. 11 is a diagram for describing an eighth embodiment. The eighth embodiment is characterized in that sensitivities (factors) to one or more predefined physical quantities are adjusted in accordance with the thicknesses of SAW devices 115 and 116. For example, a thickness D1 of a piezoelectric substrate 117a of the first SAW device 115 and a thickness D2 of a piezoelectric substrate 117b of the second SAW device 116 are changed to change sensitivities dependent on a physical quantity.

FIG. 11 is a diagram of the respective attachment relationships between the first and second SAW devices 115 and 116 and a crankshaft 2, which is the subject to be measured. Joining materials 117 and 118 are disposed on an outer circumferential surface of the crankshaft 2. The first and second SAW devices 115 and 116 are attached on the outer circumferential surface of the crankshaft 2 with the joining materials 117 and 118. The piezoelectric substrates 117a and 117b of the first and second SAW devices 115 and 116 have the thicknesses D1 and D2, which are different from each other.

When a turning force from the rotation of the crankshaft 2 is applied to the piezoelectric substrates 117a and 117b, the phase angles θa and θb change in a manner dependent on a physical quantity that affects the first and second SAW devices 115 and 116 and in accordance with the difference between the thicknesses D1 and D2 of the piezoelectric substrates 117a and 117b. Sensitivities that vary with one or more predefined physical quantities can be changed and adjusted with the thicknesses set as described above.

### Ninth Embodiment

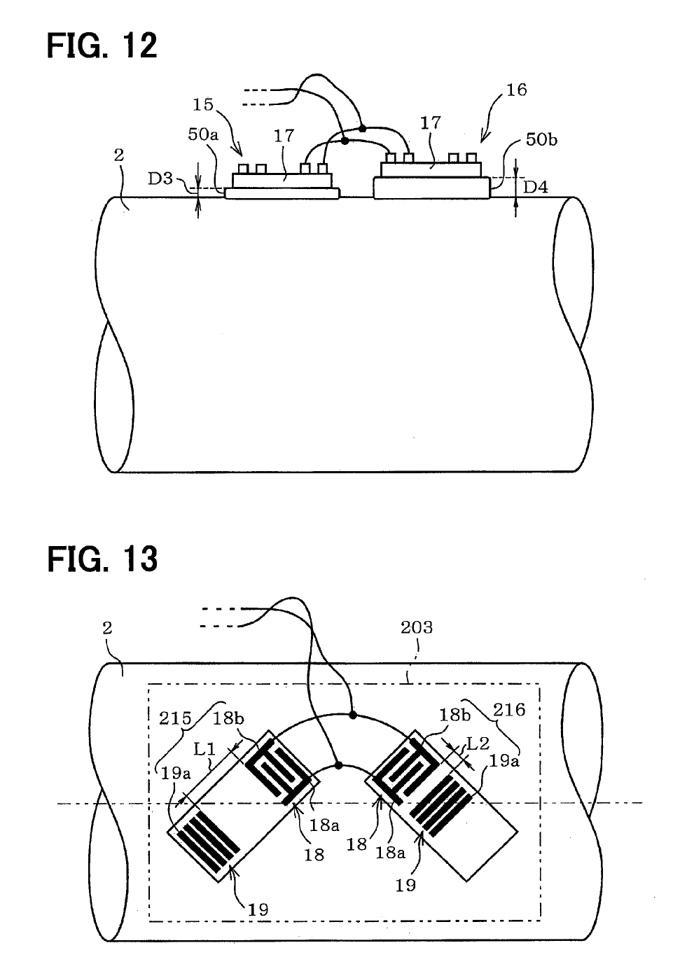

FIG. 12 is a diagram for describing a ninth embodiment. The ninth embodiment is characterized in that sensitivities (factors) to one or more specific physical quantities are adjusted in accordance with the thicknesses of joining materials 50a and 50b for attaching SAW devices 15 and 16 to a crankshaft 2, which is the subject to be measured. For example, a thickness D3 of the joining material 50a for the first SAW device 15 and a thickness D4 of the joining material 50b for the second SAW device 16 are changed to change sensitivities dependent on one or more predefined physical quantities.

FIG. 12 is a diagram of the respective attachment relationships between the first and second SAW devices 15 and 16 and the crankshaft 2. The joining materials 50a and 50b are formed on an outer circumferential surface of the crankshaft 2. The first and second SAW devices 15 and 16 are attached on the outer circumferential surface of the crankshaft 2 with the joining materials 50a and 50b. Although piezoelectric substrates 17 of the first and second SAW devices 15 and 16 have an identical thickness, the thicknesses D3 and D4 of the joining materials 50a and 50b are different from each other.

When a turning force from the rotation of the crankshaft 2 is applied to the piezoelectric substrates 17 uniformly, the phase angles θa and θb change in a manner dependent on a physical quantity that affects the first and second SAW devices 15 and 16 and in accordance with the difference between the thicknesses D3 and D4 of the joining materials 50a and 50b, which are for attaching the piezoelectric substrates 17. Sensitivities (factors) that vary with one or more predefined physical quantities can be changed with the thicknesses set as described above.

### Tenth Embodiment

FIG. 13 is a diagram for describing a tenth embodiment. The tenth embodiment is characterized in that sensitivities (factors) to one or more specific physical quantities are adjusted in accordance with the lengths of propagation lines of SAW devices 215 and 216. FIG. 13 is a diagram of the relationship between the lengths L1 and L2 of the propagation lines of the first and second SAW devices 215 and 216.

In the present embodiment, the length L1 of the propagation line between an interdigital transducer 18 and a reflector 19 in the first SAW device 215 and the length L2 of the propagation line between an interdigital transducer 18 and a reflector 19 in the second SAW device 216 are changed to change sensitivities. The phase angles θa and θb to be obtained change in accordance with the relationship between the length L1 of the propagation line of the first SAW device 215 and the length L2 of the propagation line of the second SAW device 216, where L2<L1 or L2>L1. Sensitivities (factors) that vary with one or more predefined physical quantities can be changed with the setting as described above.

### Eleventh Embodiment

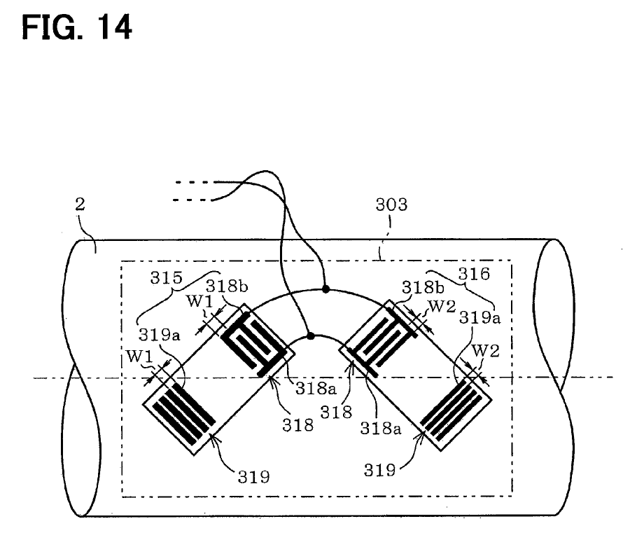

FIG. 14 is a diagram for describing an eleventh embodiment. The eleventh embodiment is characterized in that sensitivities (factors) to one or more specific physical quantities are adjusted in accordance with the operating frequencies and resonance frequencies of SAW devices 315 and 316.

FIG. 14 is a diagram of a schematic configuration of an interdigital transducer 318 and a reflector 319 of each of the first and second SAW devices 315 and 316. The interdigital transducer 318 of each of the first and second SAW devices 315 and 316 includes electrodes 318a and 318b. The reflector 319 of each of the first and second SAW devices 315 and 316 includes electrodes 319a. In the first SAW device 315, the sum of a width of one of the electrodes 318a and 318b of the interdigital transducer 318 in the SAW propagation direction and a spacing between the electrodes 318a and 318b is defined as a pitch W1, and the sum of a width of one of the electrodes 319a of the reflector 319 in the SAW propagation direction and a spacing between two of the electrodes 319a is defined as a pitch W1. In the second SAW device 316, the sum of a width of one of the electrodes 318a and 318b of the interdigital transducer 318 in the SAW propagation direction and a spacing between the electrodes 318a and 318b is defined as a pitch W2, and the sum of a width of one of the electrodes 319a of the reflector 319 in the SAW propagation direction and a spacing between two of the electrodes 319a is defined as a pitch W2. The first and second SAW devices 315 and 316 are configured in such a manner that the pitches W1 and W2 of the respective interdigital transducers 318 are different from each other. The first and second SAW devices 315 and 316 are also configured in such a manner that the pitches W1 and W2 of the electrodes of the respective reflectors 319 are different from each other. The phase angles θa and θb to be obtained change in accordance with the difference between the pitches W1 and W2. Sensitivities (factors) that vary with one or more predefined physical quantities can be changed with the setting as described above.

### Twelfth Embodiment

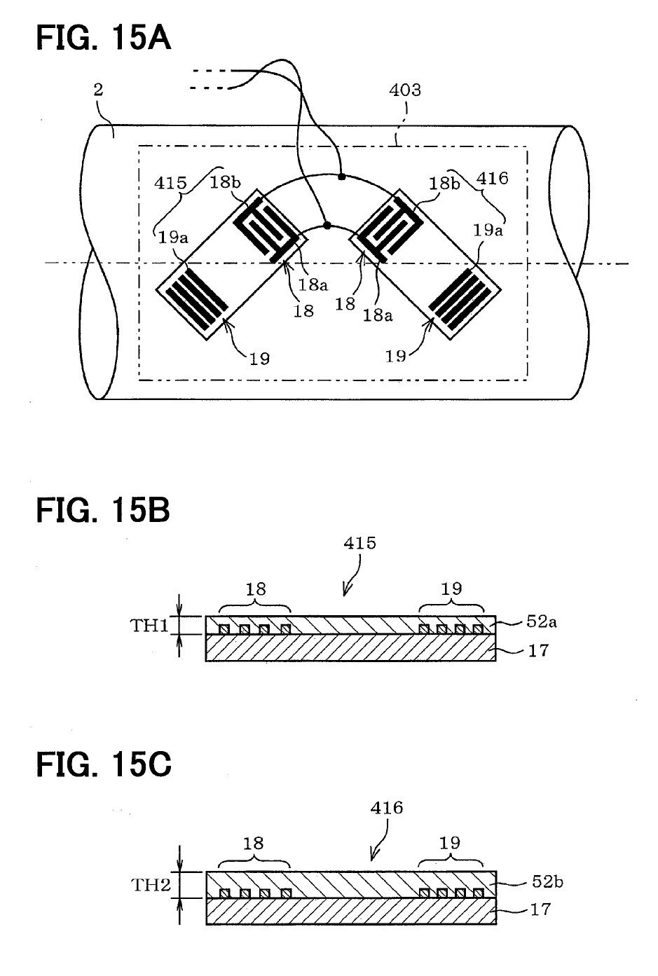

FIGS. 15A to 15C are diagrams for describing a twelfth embodiment. The twelfth embodiment is characterized in that sensitivities (factors) to one or more specific physical quantities are adjusted in accordance with the thicknesses of characteristic-adjusting coating layers of SAW devices 415 and 416.

FIG. 15A is a diagram of a schematic layout of the first and second SAW devices 415 and 416, FIG. 15B is a schematic sectional view of the first SAW device 415, and FIG. 15C is a schematic sectional view of the second SAW device 416.

As illustrated in FIG. 15A, the positional relationship between an interdigital transducer 18 and a reflector 19 in each of the first and second SAW devices 415 and 416 is not changed from that between the interdigital transducer 18 and the reflector 19 in each of the first and second SAW devices 15 and 16 according to the first embodiment. As illustrated in FIGS. 15B and 15C, the first and second SAW devices 415 and 416 include characteristic-adjusting coating layers 52a and 52b, respectively. The characteristic-adjusting coating layers 52a and 52b, which are made from, for example, SiO₂ and cover the interdigital transducer 18 and the reflector 19 on a piezoelectric substrate 17, have respective thicknesses TH1 and TH2, which are different from each other.

Thermal expansion and SAW speed change differently in accordance with a change in temperature Te and in accordance with the difference between the thicknesses TH1 and TH2 of the coating layers 52a and 52b. The coating layers 52a and 52b may be formed on any one or both of the SAW devices 415 and 416. The phase angles θa and θb change accordingly. A sensitivity (a factor) that varies with one or more predefined physical quantities can be changed with the setting as described above.

### Thirteenth Embodiment

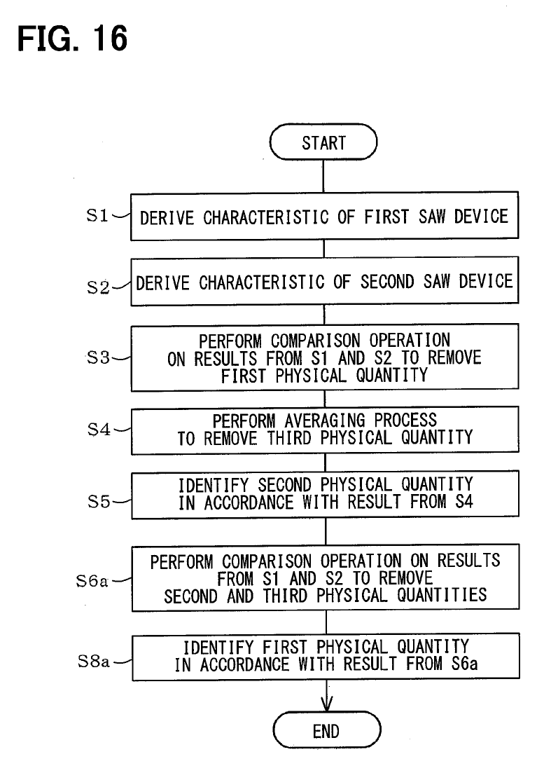

FIG. 16 is a diagram for describing a thirteenth embodiment. If the ratios of the sensitivities (factors) Hb/Ha and Fb/Fa are equal to each other in, for example, the processing described in the first embodiment, the effects of the second and third physical quantities (Ga, Gb, Ha, and Hb, for example) are removed simultaneously when the processing is performed (S6a in FIG. 16). Then, the first physical quantity (the torque To, for example) can be calculated immediately (S8a in FIG. 16). The controller 20 may detect the first physical quantity (the torque To, for example) in a manner dependent on the operational expressions described above.

### Other Embodiments

The embodiments described above are not limitations. The embodiments described above can be modified or expanded as described below, for example.

While the first SAW devices 15, 115, 215, 315, and 415 and the second SAW devices 16, 116, 216, 316, and 416 are described in the first to thirteenth embodiments, their configurations can be combined as appropriate.

If the ratios of the sensitivities (factors) Fb/Fa and Hb/Ha described above are both constants, each of the sensitivities Fa, Fb, Ha, and Hb can be replaced with a function of the temperature Te. Hence, in a state where such operational expressions corresponding to the temperature Te are programmed and stored in the storage 22, the controller 20 may calculate the sensitivities Fa, Fb, Ha, and Hb in accordance with the operational expressions to determine them in advance.

The operating frequencies of the excitation signal and the detection signal may be raised to increase sensitivities of the phase angles θa and θb to a physical quantity, and they may be lowered to reduce the sensitivities. Hence, when a sensing system 1 including a reflective SAW delay device is used, the operating frequencies of its excitation signal and detection signal may be changed to adjust sensitivities of the phase angles θa and θb.

While calculation of a physical quantity that acts on the crankshaft 2 has been described with the crankshaft 2 defined as the subject on which the SAW sensor 3 is attached, this is not a limitation. The subject on which the SAW sensor 3 is attached is not limited to the crankshaft 2. Additionally, a physical quantity that acts on the SAW sensor 3 itself may be calculated.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A sensing system, comprising:
a surface acoustic wave sensor including a first surface acoustic wave device and a second surface acoustic wave device;
a sensing apparatus that is communicably connected to the surface acoustic wave sensor, and that detects an electrical characteristic of the first surface acoustic wave device and an electrical characteristic of the second surface acoustic wave device of the surface acoustic wave sensor; and
a control apparatus that calculates at least one physical quantity, which acts on one of a target to which the surface acoustic wave sensor is attached and the surface acoustic wave sensor, based on a sensor signal detected by the sensing apparatus, wherein:
the at least one physical quantity includes a first physical quantity, a second physical quantity, and a third physical quantity;
a ratio of a sensitivity of the first physical quantity of the first surface acoustic wave device to a sensitivity of the first physical quantity of the second surface acoustic wave device is different from a ratio of a sensitivity of the second physical quantity of the first surface acoustic wave device to a sensitivity of the second physical quantity of the second surface acoustic wave device;
the third physical quantity is removable from the at least one physical quantity by performing an averaging process; and
the control apparatus calculates the second physical quantity
by removing the first physical quantity from the at least one physical quantity based on a result of a comparison operation between a sensor signal from the first surface acoustic wave device and a sensor signal from the second surface acoustic wave device, and
by performing the averaging process to regard the third physical quantity as a predetermined value and to remove the third physical quantity from the at least one physical quantity.

2. The sensing system according to claim 1,
wherein the control apparatus calculates the first physical quantity
by removing the third physical quantity from the at least one physical quantity based on a result of a comparison operation between a sensor signal from the first surface acoustic wave device and a sensor signal from the second surface acoustic wave device, and
by removing the calculated second physical quantity from the at least one physical quantity.

3. The sensing system according to claim 2,
wherein the control apparatus calculates the third physical quantity from the at least one physical quantity by using the first physical quantity and the second physical quantity, which are calculated by control apparatus.

4. The sensing system according to claim 1, wherein:
the ratio of a sensitivity of the second physical quantity of the first surface acoustic wave device to a sensitivity of the second physical quantity of the second surface acoustic wave device is equal to the sensitivity of the third physical quantity of the first surface acoustic wave device to a sensitivity of the third physical quantity of the second surface acoustic wave device; and
the control apparatus calculates the first physical quantity by removing the third physical quantity and the second physical quantity from the at least one physical quantity based on the result of the comparison operation between a sensor signal from the first surface acoustic wave device and the sensor signal from the second surface acoustic wave device.

5. The sensing system according to claim 1, further comprising:
a number-of-times setting sensor that calculates a number of times to perform the averaging process,
wherein the control apparatus performs the averaging process
to regard the third physical quantity as a predetermined value, and
to remove the third physical quantity from the at least one physical quantity by using the number of times to perform the averaging process which is calculated by the number-of-times setting sensor.

6. The sensing system according to claim 1,
wherein the control apparatus uses a torque as the first physical quantity, a temperature as the second physical quantity, and a deflection as the third physical quantity.

7. The sensing system according to claim 1, further comprising:
an antenna that enables a transmission signal and a reception signal to propagate between the sensing apparatus and one or another one of the first surface acoustic wave device and the second surface acoustic wave device, wherein:
the sensing apparatus detects a sensor signal, which propagates to the first surface acoustic wave device and the second surface acoustic wave device through the antenna; and
the control apparatus calculates the at least one physical quantity by using a torque as the first physical quantity, a temperature as the second physical quantity, and a phase change characteristic of the antenna as the third physical quantity.

8. The sensing system according to claim 1,
wherein the third physical quantity is removable from the at least one physical quantity
by performing the averaging process on information included in a sensor signal detected by the sensing apparatus to calculate the third physical quantity subjected to the averaging process, and
by removing the third physical quantity subjected to the averaging process from the at least one physical quantity.
